(19) United States
(12) Patent Application Publication
(10) Pub. No.: US 2021/0276397 A1
(43) Pub. Date: Sep. 9, 2021

(54) AIR-CONDITIONING UNIT FOR VEHICLE

(71) Applicant: DENSO CORPORATION, Kariya-city (JP)

(72) Inventor: Takahiro NAKAJIMA, Kariya-city (JP)

(21) Appl. No.: 17/328,717

(22) Filed: May 24, 2021

Related U.S. Application Data
(63) Continuation of application No. PCT/JP2019/045667, filed on Nov. 21, 2019.

(30) Foreign Application Priority Data
Dec. 26, 2018 (JP) 2018-243173

(51) Int. Cl. B60H 1/00

(52) U.S. Cl. CPC B60H 1/00564

(57) ABSTRACT

An air-conditioning unit includes: an air-conditioning case in which an in-case passage is formed; and a blower having a blower fan arranged in the in-case passage to rotate around a fan axis so as to blow out air sucked from one side in an axial direction. A rectifying mechanism is arranged downstream of the blower fan in a flow of air in the in-case passage to define a rectifying passage to rectify a swirling flow generated by the rotation of the blower fan relative to the air blown from the blower fan. The rectifying mechanism includes a contracting rectifying passage having an inlet into which the swirling flow flows and an outlet through which the rectified air flows out. A flow path area of the outlet is smaller than a flow path area of the inlet.

### CROSS REFERENCE TO RELATED APPLICATIONS

The present application is a continuation application of International Patent Application No. PCT/JP2019/045667 filed on Nov. 21, 2019, which designated the U.S. and claims the benefit of priority from Japanese Patent Application No. 2018-243173 filed on Dec. 26, 2018. The entire disclosures of all of the above applications are incorporated herein by reference.

### TECHNICAL FIELD

The present disclosure relates to an air-conditioning unit for a vehicle.

### BACKGROUND

An air-conditioning unit for a vehicle includes: an air conditioning case in which an in-case passage is defined for air to flow; and a blower that blows air out of the air-conditioning unit toward a cabin. The blower has a centrifugal fan that rotates around a fan axis to blow out air sucked from one side in an axial direction of the fan axis outward in a radial direction.

### SUMMARY

According to one aspect of the present disclosure, an air-conditioning unit for a vehicle includes: an air-conditioning case in which an in-case passage is defined for air to be blown into a cabin; a blower having a blower fan arranged in the in-case passage to rotate around a fan axis so as to blow out air sucked from one side in an axial direction of the fan axis; and a rectifying mechanism arranged downstream of the blower fan in a flow of air in the in-case passage. A rectifying passage is defined in the rectifying mechanism to rectify a swirling flow generated by rotation of the blower fan relative to the air blown from the blower fan. The rectifying mechanism includes a contracting rectifying passage having an inlet into which the swirling flow flows and an outlet through which the rectified air flows out, and a flow path area of the outlet is smaller than a flow path area of the inlet.

### BRIEF DESCRIPTION OF DRAWINGS

FIG. 1 is a schematic cross-sectional view showing a partial configuration of an air-conditioning unit for a vehicle in a first embodiment.

FIG. 2 is a cross-sectional view taken along a line II-II in FIG. 1.

FIG. 3 is a cross-sectional view taken along a line III-III in FIG. 2, showing a schematic shape of a rectifying mechanism of the first embodiment.

FIG. 4 is a diagram showing a comparative example.

FIG. 5 is a cross-sectional view showing a schematic shape of a rectifying mechanism of a second embodiment, corresponding to FIG. 3.

FIG. 6 is a cross-sectional view showing a schematic shape of a rectifying mechanism of a third embodiment, corresponding to FIG. 3.

FIG. 7 is a cross-sectional view showing a schematic shape of a rectifying mechanism of a fourth embodiment, corresponding to FIG. 3.

FIG. 8 is a cross-sectional view illustrating a rectifying mechanism of a fifth embodiment, corresponding to FIG. 3.

FIG. 9 is a cross-sectional view taken along a line IX-IX in FIG. 8, showing the rectifying mechanism of the fifth embodiment.

FIG. 10 is a cross-sectional view taken along a line XX in FIG. 8, showing the rectifying mechanism of the fifth embodiment.

FIG. 11 is a diagram for explaining a problem to be solved.

### DESCRIPTION OF EMBODIMENT

To begin with, examples of relevant techniques will be described.

An air-conditioning unit for a vehicle includes: an air conditioning case in which an in-case passage is defined for air to flow; and a blower that blows air out of the air-conditioning unit toward a cabin. Since the blower is a centrifugal blower, the blower has a centrifugal fan that rotates around a fan axis to blow out air sucked from one side in an axial direction of the fan axis outward in a radial direction. The centrifugal fan is arranged at the upstream side in the in-case passage in the flow of air. The air blown out from the centrifugal fan flows inside the in-case passage.

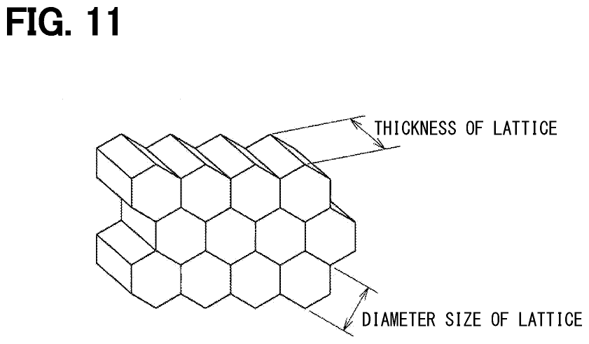

According to study by the inventor, in such an air-conditioning unit, a rectifying mechanism may be provided on the downstream side in the air flow in the in-case passage for rectifying a swirling flow of air blown out from the blower. For example, it is possible to suppress a swirling flow by providing a rectifying mechanism having a honeycomb structure as shown in FIG. 11. If the lattice size is large, a sufficient rectification performance cannot be obtained. In this case, it is possible to improve the rectification performance by increasing the length of the rectifying mechanism in the thickness direction.

However, in such an air-conditioning unit, there is a demand for shortening the length of the air-conditioning case in the longitudinal direction as much as possible in order to reduce the size. Therefore, in order to shorten the length of the rectifying mechanism in the thickness direction and secure the rectification performance, it is necessary to reduce the lattice size. However, if the lattice size is reduced, the pressure loss becomes large.

The present disclosure provides an air-conditioning unit to reduce pressure loss and to obtain a desired rectification effect without increasing the length of the rectifying mechanism in the thickness direction.

According to one aspect of the present disclosure, an air-conditioning unit for a vehicle includes: an air-conditioning case in which an in-case passage is defined for air to be blown into a cabin; a blower having a blower fan arranged in the in-case passage to rotate around a fan axis so as to blow out air sucked from one side in an axial direction of the fan axis; and a rectifying mechanism arranged downstream of the blower fan in a flow of air in the in-case passage. A rectifying passage is defined in the rectifying mechanism to rectify a swirling flow generated by rotation of the blower fan relative to the air blown from the blower fan.

The rectifying mechanism includes a contracting rectifying passage having an inlet into which the swirling flow flows and an outlet through which the rectified air flows out, and a flow path area of the outlet is smaller than a flow path area of the inlet.

Accordingly, the rectifying mechanism is formed with the contracting rectifying passage in which the flow path area of the outlet where the rectified air flows out is smaller than the flow path area of the inlet where the swirling flow flows in. Therefore, it is possible to reduce the pressure loss and obtain a desired rectifying effect without increasing the length of the rectifying mechanism in the thickness direction.

The reference numerals attached to the components and the like indicate an example of correspondence between the components and the like and specific components and the like described in embodiments below.

Hereinafter, embodiments of the present disclosure will be described with reference to the drawings. In the following embodiments, identical or equivalent elements are denoted by the same reference numerals as each other in the figures.

### First Embodiment

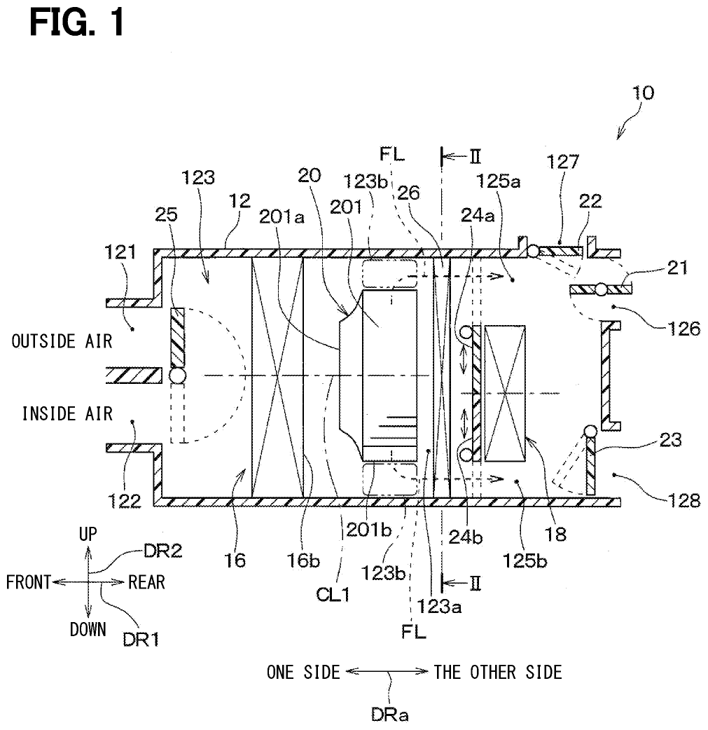

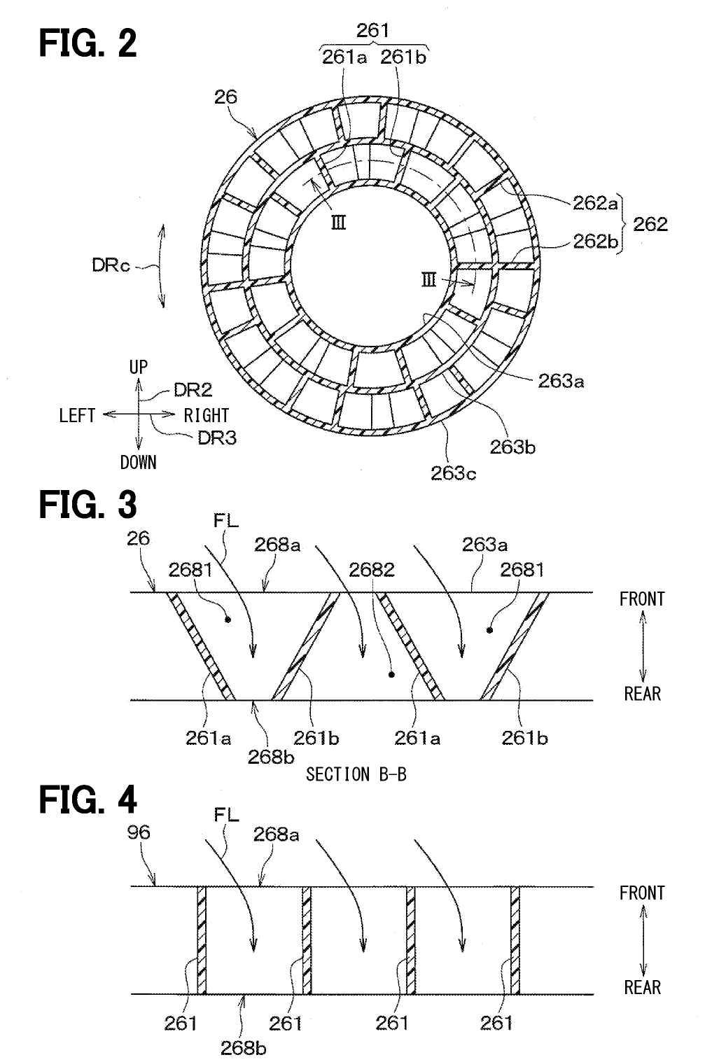

An air-conditioning unit for a vehicle according to a first embodiment will be described with reference to FIGS. 1 to 4. As shown in FIG. 1, the air-conditioning unit 10 of the present embodiment includes an air-conditioning case 12, an evaporator 16, a heater core 18, a blower 20, plural doors 21, 22, 23, 24a, 24b, 25, and a rectifying mechanism 26. The air-conditioning unit 10 is arranged, for example, inside an instrument panel provided at the foremost portion in a cabin. Arrows DR1, DR2, DR3 in FIG. 1 and FIG. 2 represent directions when the air-conditioning unit 10 is mounted on the vehicle. That is, the arrow DR1 in FIG. 1 represents a front-rear direction DR1 of the vehicle. The arrow DR2 represents an up-down direction DR2 of the vehicle. In FIG. 2, the arrow DR3 represents a left-right direction DR3 of the vehicle, i.e. a width direction DR3 of the vehicle. The directions DR1, DR2, DR3 intersect with each other. Specifically, the directions DR1, DR2, DR3 are orthogonal to each other.

The air-conditioning case 12 forms an outer shell of the air-conditioning unit 10 and is made of plastic material. The air-conditioning case 12 has an outside air introduction port 121, an inside air introduction port 122, and air outlets 126, 127, 128 to blow out air from the air-conditioning case 12. The air-conditioning case 12 defines therein an in-case passage 123 through which the air flows from one or both of the outside air introduction port 121 and the inside air introduction port 122 to the air outlets 126, 127, 128. The in-case passage 123 extends in the front-rear direction DR1 of the vehicle.

The outside air introduction port 121 introduces outside air, which is air outside the cabin, into the in-case passage 123. The inside air introduction port 122 introduces inside air, which is air inside the cabin, into the in-case passage 123. The outside air or the inside air is introduced into the air-conditioning case 12 by the blower 20.

The outside air introduction port 121 and the inside air introduction port 122 are opened and closed by an inside/outside air switching door 25. The air introduced from one or both of the outside air introduction port 121 and the inside air introduction port 122 flows into the evaporator 16.

The evaporator 16 is a cooling heat exchanger that cools the air passing through the evaporator 16. In short, the evaporator 16 is a cooler.

The evaporator 16 is housed in the air-conditioning case 12. That is, the evaporator 16 is disposed in the in-case passage 123 so that the outside air or the inside air introduced into the in-case passage 123 flows through the evaporator 16. The evaporator 16 constitutes a known refrigeration cycle device, together with a compressor, a condenser, and an expansion valve (not shown), for circulating refrigerant. The evaporator 16 exchanges heat between the air passing through the evaporator 16 and the refrigerant, to evaporate the refrigerant and cool the air by the heat exchange.

The blower 20 has a blower fan 201 that rotates around a fan axis CL1 in the in-case passage 123 and a fan motor (not shown) that rotationally drives the blower fan 201. The blower fan 201 is a centrifugal fan in the present embodiment. The blower 20 which is a centrifugal blower sucks air from one side in the axial direction DRa of the fan axis CL1 by the rotation of the blower fan 201, and blows out the air in the radial direction of the blower fan 201. The air blown out in the radial direction is guided by the air-conditioning case 12 to the downstream side (for example, the rear side of the vehicle in FIG. 1) in the air flow in the in-case passage 123, as shown by the arrow FL.

The axial direction DRa of the fan axis CL1 coincides with the front-rear direction DR1 in this embodiment. Further, the axial direction DRa of the fan axis CL1 is also referred to as the fan axial direction DRa. In addition, the radial direction of the blower fan 201 is a radial direction of the fan axis CL1. The radial direction of the fan axis CL1 is also referred to as a fan radial direction.

The blower 20 has a so-called suction-type layout in which the blower fan 201 is located downstream of the evaporator 16 in the air flow. The blower 20 is arranged so that one side in the fan axial direction DRa, which is an air suction side of the blower fan 201, faces an air outflow surface 16b of the evaporator 16. Therefore, the blower fan 201 is arranged so that the other side of the fan axis CL1, which is opposite to the one side in the fan axial direction DRa, extends toward the downstream side of the air flow in the in-case passage 123.

Specifically, the blower 20 is arranged so that the fan axis CL1 is substantially orthogonal to the air outflow surface 16b of the evaporator 16. Therefore, the blower fan 201 is arranged so that the other side of the fan axis CL1 extends in the extending direction in which a fan downstream portion 123a of the in-case passage 123 extends (specifically, toward the rear side of the vehicle). The fan downstream portion 123a is a downstream portion of the in-case passage 123 in the air flow by the blower fan 201. That is, the air flow blown out from the blower fan 201 proceeds to the other side in the fan axial direction DRa in the in-case passage 123.

The heater core 18 is located downstream of the blower fan 201 in the in-case passage 123. The heater core 18 is arranged at a center part in the in-case passage 123 in the up-down direction DR2 of the vehicle. The heater core 18 is a heater that heats air passing through the heater core 18 in the in-case passage 123.

The air-conditioning case 12 has an upper bypass passage 125a defined above the heater core 18, and a lower bypass passage 125b defined below the heater core 18. Both of the upper bypass passage 125a and the lower bypass passage 125b are included in the in-case passage 123 and allow the air to flow in parallel to the heater core 18. That is, the air passing through the upper bypass passage 125a and the lower bypass passage 125b bypasses the heater core 18. In other words, both of the upper bypass passage 125a and the lower bypass passage 125b are non-heating passages in which the heater core 18 is not provided.

A first air mix door 24a and a second air mix door 24b are provided at the upstream side of the heater core 18 in the air flow in the in-case passage 123. The first air mix door 24a and the second air mix door 24b are provided on the downstream side of the rectifying mechanism 26 in the air flow.

The first air mix door 24a is arranged in the upper bypass passage 125a to open/close the upper bypass passage 125a. The first air mix door 24a is a slide-type door mechanism, and is slid by an electric actuator (not shown).

The first air mix door 24a adjusts a ratio between an air volume passing through the heater core 18 and an air volume passing through the upper bypass passage 125a according to a slide position thereof.

The second air mix door 24b is disposed in the lower bypass passage 125b to open/close the lower bypass passage 125b. The second air mix door 24b is a slide-type door mechanism, and is slid by an electric actuator (not shown).

The second air mix door 24b adjusts a ratio between an air volume passing through the heater core 18 and an air volume passing through the lower bypass passage 124a according to a slide position thereof.

The air-conditioning case 12 has a face air outlet 126, a defroster air outlet 127, and a foot air outlet 128 through which the air flows out of the air-conditioning case 12. The face air outlet 126, the defroster air outlet 127, and the foot air outlet 128 are connected to the in-case passage 123 at the downstream side with respect to the heater core 18 and the bypass passage 125a, 125b.

The air flowing through the face air outlet 126 is guided through a duct (not shown), and is blown out toward the face or the chest of an occupant seated on a front seat in the cabin. The air flowing through the defroster air outlet 127 is guided through a duct (not shown), and is blown out toward a windshield in the cabin of the vehicle. The air flowing through the foot air outlet 128 is guided through a duct (not shown), and is blown out toward the feet of an occupant seated on the front seat in the cabin.

The face air outlet 126 is provided with a face door 21 to open/close the face air outlet 126. The defroster air outlet 127 is provided with a defroster door 22 to open/close the defroster air outlet 127. The foot air outlet 128 is provided with a foot door 23 to open/close the foot air outlet 128.

Warm air passing through the heater core 18 and cool air passing through the upper bypass passage 125a are mixed with each other at the downstream side of the heater core 18 in the in-case passage 123. The mixed air is blown out mainly from an opened one of the face air outlet 126 and the defroster air outlet 127 into the cabin.

Warm air passing through the heater core 18 and cool air passing through the lower bypass passage 125b are mixed with each other at the downstream side of the heater core 18. The mixed air is blown out mainly from the foot air outlet 128 into the cabin when the foot air outlet 128 is open.

The air-conditioning case 12 is provided with plural face air outlets 126. For example, when a blow-out mode of the air-conditioning unit 10 is set to a face mode, the face air outlets 126 are opened, and the defroster air outlet 127 and the foot air outlet 128 are closed. In this case, the air passing through the rectifying mechanism 26 arranged at the upstream side of the face air outlets 126 is distributed into each of the face air outlets 126. The air passing through the rectifying mechanism 26 is not distributed to the defroster air outlet 127 and foot air outlet 128 which are closed. The air outlets into which the air passing through the rectifying mechanism 26 is distributed specifically mean air outlets simultaneously opened in any one of blow-out modes.

The rectifying mechanism 26 is arranged in the in-case passage 123 downstream of the blower fan 201 in the air flow, and is arranged upstream of the heater core 18 and the air mix door 24a, 24b in the air flow.

Since the blower fan 201 is arranged so that the other side in the fan axial direction DRa faces the downstream side in the in-case passage 123, a swirl flow is generated by the rotation of the blower fan 201 in the air blown out from the blower fan 201 to flow into the rectifying mechanism 26.

The rectifying mechanism 26 rectifies the swirling flow generated by the rotation of the blower 20 in the air blown from the blower 20. The air blown out from the blower fan 201 flows into the rectifying mechanism 26, and the air is rectified by the rectifying mechanism 26 to flow into the bypass passage 125a, 125b or the heater core 18.

As shown in FIGS. 2 to 3, the rectifying mechanism 26 includes cylindrical tubular portions 263a, 263b, 263c, and rectifying plates 261 to 262 extending from the inner side to the outer side of the blower fan 201 in the radial direction. The tubular portions 263a to 263c and the rectifying plates 261 to 262 are integrally formed and fixed to the air-conditioning case 12. That is, the rectifying mechanism 26 is provided as a non-rotating member that is fixed to the air-conditioning case 12.

The tubular portions 263a to 263c are arranged concentrically around the fan axis CL1. The inner diameter of the tubular portion 263a is smaller than the inner diameter of the tubular portion 263b. The inner diameter of the tubular portion 263b is smaller than the inner diameter of the tubular portion 263c. That is, the tubular portion 263c is spaced from the outer side of the tubular portion 263b in the radial direction of the blower fan 201. The tubular portion 263b is spaced from the outer side of the tubular portion 263a in the radial direction of the blower fan 201.

The rectifying plates 261 to 262 are arranged with respect to the tubular portions 263a to 263c. The rectifying plate 261, 262 is arranged so as to be spaced apart from each other in the fan circumferential direction DRc. Specifically, the rectifying plate 261 is arranged between the tubular portion 263a and the tubular portion 263b, and the rectifying plate 262 is arranged between the tubular portion 263b and the tubular portion 263c.

The rectifying plate 261 has rectifying plates 261a to 261b facing with each other. The rectifying plates 261a to 261b are arranged side by side so as to extend from the inlet 268a into which the swirling flow flows to the outlet 268b from which the rectified air flows out.

As shown in FIG. 3, rectifying passage 2681 to 2682 are formed between the rectifying plate 261a and the rectifying plate 261b to rectify the swirling flow FL generated by the rotation of the blower 20. Specifically, a contracting rectifying passage 2681 and an enlarging rectifying passage 2682 are formed between the rectifying plate 261a and the rectifying plate 261b.

The flow path area of the outlet 268b through which the rectified air flows out is smaller than the flow path area of the inlet 268a in which the swirling flow FL flows, in the contracting rectifying passage 2681. The flow path area of the outlet 268b in which the rectified air flows out from the rectified passage is larger than the flow path area of the inlet 268a in which the swirling flow FL flows in, in the enlarging rectifying passage 2682.

The air blown from the blower fan 201 flows into the rectifying mechanism 26, and the air flows through the contracting rectifying passage 2681 and the enlarging rectifying passage 2682. Since the flow path area of the inlet 268a of the contracting rectifying passage 2681 is larger than the flow path area of the inlet 268a of the enlarging rectifying passage 2682, the contracting rectifying passage 2681 has more inflow air than the enlarging rectifying passage 2682.

The rectifying mechanism 26 satisfactorily rectifies the swirling flow FL generated by the rotation of the blower 20 when the air blown from the blower fan 201 passes through the contracting rectifying passage 2681.

In the rectifying mechanism 26 of the present embodiment, the contracting rectifying passage 2681 is formed by shortening the distance between the rectifying plates 261a and 261b as approaching the outlet 268b from the inlet 268a.

FIG. 4 shows a rectification mechanism 96 in a comparative example in which a rectifying plate 261 is formed so as to extend in the normal direction of the inlet 268a, and the flow path area of the rectifying passage 268 is constant from the inlet 268a to the outlet 268b. In the comparative example, the flow path area of the rectifying passage 268 is constant, and the area of the inlet 268a is relatively small, such that the pressure loss becomes large. In order to obtain a desired rectifying effect, it is necessary to increase the length of the rectifying mechanism 26 in the thickness direction, that is, to increase the length of the rectifying passage 268.

In contrast, the rectifying mechanism 26 of the present embodiment has the inlet 268a with the larger flow path area, so that the pressure loss can be reduced. Further, since the distance between the rectifying plates 261a and 261b becomes shorter as approaching to the outlet 268b from the inlet 268a, the rotational component of the swirling flow is suppressed. Thus, it is possible to obtain the desired rectifying effect without increase in the length of the rectifying passage 268.

That is, the rectifying mechanism 26 of the present embodiment includes the contracting rectifying passage 2681 in which the flow path area of the outlet 268b through which the rectified air flows out is smaller than the flow path area of the inlet 268a in which the swirling flow flows in. Therefore, it is possible to obtain a desired rectifying effect without increasing the length of the rectifying mechanism 26 in the thickness direction.

Next, an operation of the air-conditioning unit 10 will be described. When the blower 20 starts an operation, as shown in FIG. 1, air is introduced into the in-case passage 123 formed in the air-conditioning case 12 through the outside air introduction port 121 or the inside air introduction port 122. The air introduced into the in-case passage 123 is cooled by the evaporator 16, and passes through the evaporator 16.

The air cooled by the evaporator 16 is sucked into the blower fan 201 of the blower 20, is blown outward in the radial direction of the blower fan 201, and is guided to the downstream side of the in-case passage 123 in the air flow by the air-conditioning case 12.

The air blown out from the blower fan 201 passes through the rectifying mechanism 26. The air passing through the rectifying mechanism 26 becomes warm air when passing through the heater core 18, and flows to the downstream side of the heater core 18. When the air passing through the rectifying mechanism 26 flows through the bypass passage 125a, 125b, the air flows to the downstream side of the heater core 18, without being heated, as cool air. The warm air and the cool air are mixed with each other at the downstream side of the heater core 18, and the mixed air is blown out from the face air outlet 126, the defroster air outlet 127, or/and the foot air outlet 128, which are opened, to a predetermined place in the cabin.

As described above, the air-conditioning unit of the present embodiment includes the air-conditioning case 12 in which an in-case passage is formed for air blown into the cabin. Further, the air-conditioning unit includes the blower 20 having the blower fan 201 that rotates around the fan axis CL1 in the in-case passage to blow out air sucked from one side in the axial direction of the fan axis CL1 by the rotation of the blower fan 201. Further, the air-conditioning unit includes the rectifying mechanism 26 in which the rectifying passages 2681 and 2682 are arranged on the downstream side of the blower fan in the in-case passage to rectify the swirling flow generated by the rotation of the blower fan 201 in the air blown out from the blower fan 201.

The rectifying mechanism 26 has the contracting rectifying passage 2681 in which the flow path area of the outlet 268b through which the rectified air flows out is smaller than the flow path area of the inlet 268a in which the swirling flow flows in.

Accordingly, the rectifying mechanism 26 includes the contracting rectifying passage 2681 in which the flow path area of the outlet 268b through which the rectified air flows out is smaller than the flow path area of the inlet 268a in which the swirling flow flows in. Therefore, it is possible to reduce the pressure loss and obtain a desired rectifying effect without increasing the length of the rectifying mechanism in the thickness direction.

Further, the rectifying mechanism 26 has the rectifying plates 261a and 261b that partition the rectifying passages 2681 and 2682. The rectifying plates 261a and 261b are arranged side by side so as to extend from the inlet 268a to the outlet 268b of the rectifying passage 2681, 2682.

The contracting rectifying passage 2681 is formed by decreasing the interval distance between the rectifying plates 261a and 261b toward the outlet 268b of the contracting rectifying passage 2681 than the inlet 268a of the contracting rectifying passage 2681.

In this way, the rectifying plates 261a and 261b are arranged to form the contracting rectifying passage 2681, so that the distance between the rectifying plates 261a and 261b is shorter on the outlet 268b of the contracting rectifying passage 2681 than on the inlet 268a of the contracting rectifying passage 2681.

### Second Embodiment

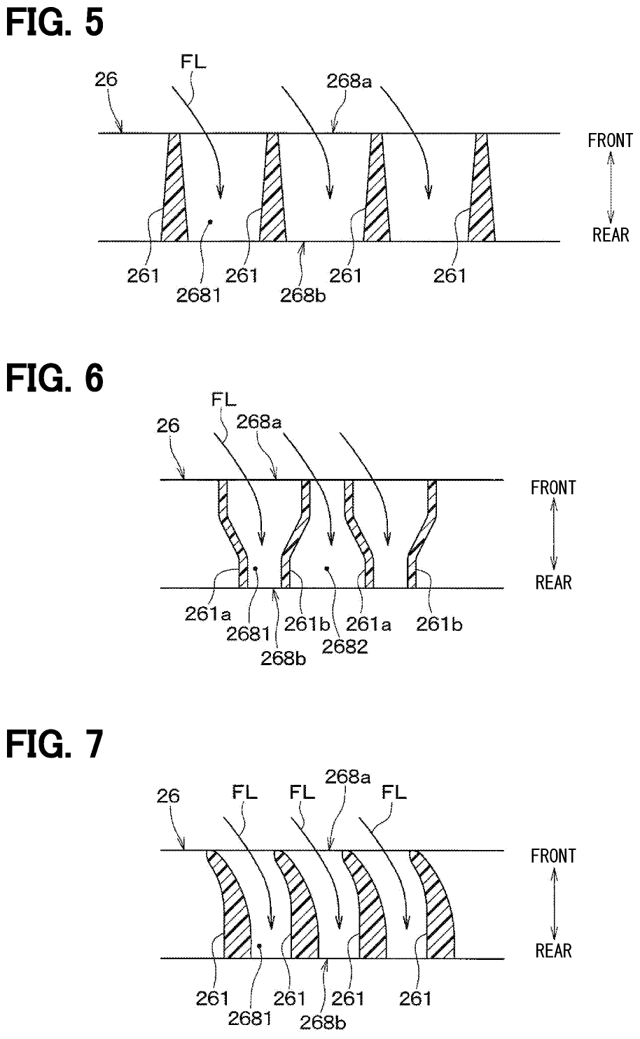

The rectifying mechanism 26 of the air-conditioning unit 10 according to the second embodiment will be described with reference to FIG. 5. In the first embodiment, the rectifying mechanism 26 has the contracting rectifying passage 2681 in which the distance between the rectifying plates 261a and 261b is shorter at the outlet 268b than at the inlet 268a.

In the present embodiment, the rectifying mechanism 26 has the rectifying plates 261 that partition and form the contracting rectifying passage 2681. The thickness of the rectifying plate 261 in the thickness direction is longer on the outlet 268b of the contracting rectifying passage 2681 than on the inlet 268a of the contracting rectifying passage 2681, whereby the contracting rectifying passage 2681 is formed.

The rectifying plates 261 are arranged so as to extend from the inlet 268a of the contracting rectifying passage 2681 to the outlet 268b. Further, the thickness of the rectifying plate 261 in the thickness direction is longer at the outlet 268b of the contracting rectifying passage 2681 than at the inlet 268a of the contracting rectifying passage 2681.

As a result, the contracting rectifying passage 2681 is formed in which the flow path area of the outlet 268b through which the rectified air flows out is smaller than the flow path area of the inlet 268a in which the swirling flow flows in.

The present embodiment can achieve the effects and advantages, which are obtained from the structure common to the first embodiment.

The rectifying mechanism 26 has the rectifying plates 261 that partition the rectifying passage. The thickness of the rectifying plate 261 in the thickness direction is larger on the outlet 268b side of the contracting rectifying passage 2681 than on the inlet 268a side of the contracting rectifying passage 2681, whereby the contracting rectifying passage 2681 is formed.

The contracting rectifying passage 2681 can be formed by arranging the rectifying plates 261 so that the length of the rectifying plate 261 in the thickness direction is longer on the outlet 268b side of the contracting rectifying passage 2681 than on the inlet 268a side of the contracting rectifying passage 2681.

### Third Embodiment

The rectifying mechanism 26 of the air-conditioning unit 10 according to the third embodiment will be described with reference to FIG. 6. In the rectifying mechanism 26 of the first embodiment, the cross-section taken along the line III-III of the rectifying plates 261a and 261b shown in FIG. 3 has a linear shape. In contrast, in the rectifying mechanism 26 of the present embodiment, the cross section of the rectifying plates 261a and 261b shown in FIG. 6 corresponding to the line III-Ill in FIG. 3 has a bent shape.

The rectifying mechanism 26 of the present embodiment has the rectifying plates 261a and 261b that partition the rectifying passages 2681 and 2682. The rectifying plates 261a and 261b are arranged side by side so as to extend from the inlet 268a toward the outlet 268b of the rectifying passage 2681, 2682.

The contracting rectifying passage 2681 is formed by the interval between the rectifying plates 261a and 261b being shorter on the outlet 268b side of the contracting rectifying passage 2681 than on the inlet 268a side of the contracting rectifying passage 2681.

The present embodiment can achieve the effects and advantages, which are obtained from the structure common to the first embodiment.

### Fourth Embodiment

The rectifying mechanism 26 of the air-conditioning unit 10 according to the fourth embodiment will be described with reference to FIG. 7. The rectifying mechanism 26 of the present embodiment has plural rectifying plates 261 that partition the rectifying passage 2681. The thickness of the rectifying plate 261 in the thickness direction is longer on the outlet 268b side of the contracting rectifying passage 2681 than on the inlet 268a side of the contracting rectifying passage 2681, whereby the contracting rectifying passage is formed. Further, the end portion of the rectifying plate 261 adjacent to the inlet 268a of the contracting rectifying passage 2681 is curved along the flow direction of the swirling flow flowing into the inlet 268a.

Specifically, the end portion of the rectifying plate 261 adjacent to the inlet 268a of the contracting rectifying passage 2681 has an arc shape curved along the flow direction of the swirling flow flowing into the inlet 268a.

The present embodiment can achieve the effects and advantages, which are obtained from the structure common to the first embodiment.

In the rectifying mechanism 26 of the present embodiment, the end portion of the rectifying plate 261 adjacent to the inlet 268a of the contracting rectifying passage 2681 is curved along the flow direction of the swirling flow flowing into the inlet 268a. Therefore, the swirling flow generated by the rotation of the blower fan 201 can be efficiently introduced into the contracting rectifying passage 2681.

Since the rectifying mechanism 26 of the present embodiment does not form the enlarging rectifying passage 2682 like the rectifying mechanism 26 of the first embodiment, the swirling flow generated by the rotation of the blower fan 201 can be extremely effectively rectified.

### Fifth Embodiment

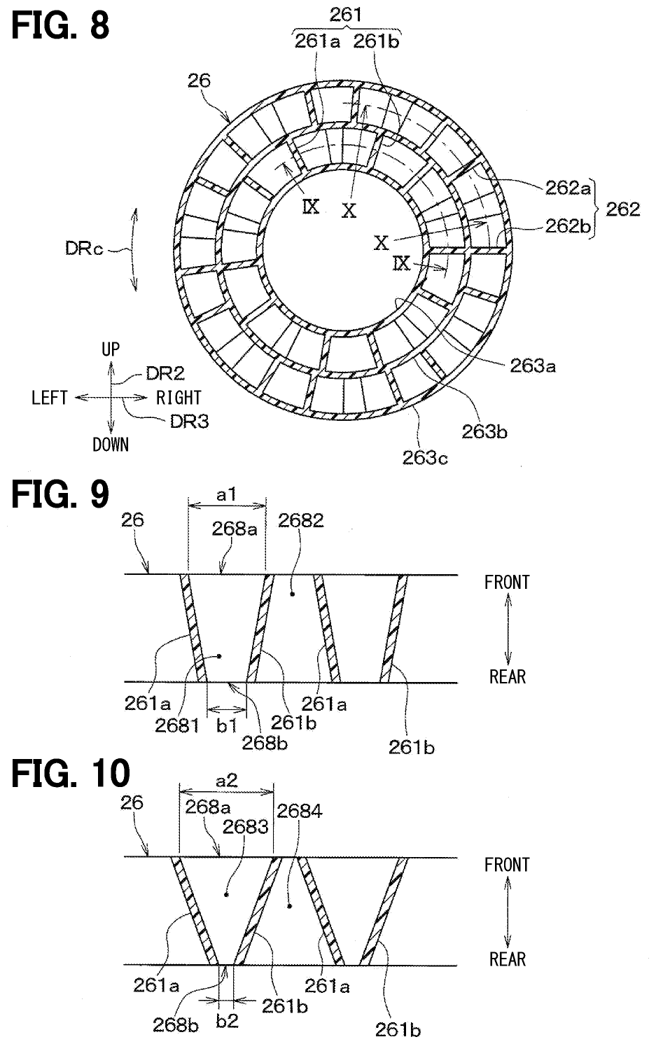

The rectifying mechanism 26 of the air-conditioning unit 10 according to the fifth embodiment will be described with reference to FIGS. 8 to 10. FIG. 9 is a cross-sectional view taken along the line IX-IX in FIG. 8, and FIG. 10 is a cross-sectional view taken along the line XX in FIG. 8.

The rectifying mechanism 26 of the present embodiment has a first tubular portion 263a and a second tubular portion 263b arranged radially outside the first tubular portion 263a so as to surround the first tubular portion 263a. Further, a third tubular portion 263c is provided so as to surround the second tubular portion 263b on the radially outside of the second tubular portion 263b.

Further, the rectifying mechanism 26 has plural first rectifying plates 261 arranged between the first tubular portion 263a and the second tubular portion 263b, to form the first contracting rectifying passage 2681 between the first tubular portion 263a and the second tubular portion 263b.

Further, the rectifying mechanism 26 has plural second rectifying plates 262 arranged between the second tubular portion 263b and the third tubular portion 263c, to form a second contracting rectifying passage 2683 between the second tubular portion 263b and the third tubular portion 263c.

The first contracting rectifying passage 2681 and the second contracting rectifying passage have the passage length t. The inlet 268a of the first contracting rectifying passage 2681, in which the swirling flow flows in, has the radial length a1. The outlet 268b from which the rectified air flows out from the first contracting rectifying passage 2681 has the radial length b1. In this case, the flow path area of the inlet 268a in which the swirling flow flows in the first contracting rectifying passage 2681 is represented by t×a1, and the flow path area of the outlet 268b from which the rectified air flows out from the first contracting rectifying passage 2681 is represented as t×b1.

Further, the inlet 268a in which the swirling flow flows in the second contracting rectifying passage 2683 is defined to have the radial length a2, and the outlet 268b in which the rectified air flows out from the second contracting rectifying passage 2683 is defined to have the radial length b2. In this case, the flow path area of the inlet 268a in which the swirling flow flows in the second contracting rectifying passage 2683 is represented by t×a2, and the flow path area of the outlet 268b from which the rectified air flows out from the second contracting rectifying passage 2683 is represented as t×b2.

A ratio of the flow path area t×a1 of the outlet 268b from which the rectified air flows out from the first contracting rectifying passage 2681 with respect to the flow path area t×b1 of the inlet 268a into which the swirling flow flows in the first contracting rectifying passage 2681 is defined as a first reduction ratio. Further, the ratio of the flow path area t×b2 of the outlet 268b from which the rectified air flows out from the second contracting rectifying passage 2683 with respect to the flow path area t×a2 of the inlet 268a into which the swirling flow flows in the second contracting rectifying passage 2683 is defined as a second reduction ratio. In this case, the second reduction ratio is smaller than the first reduction ratio. Each of the first reduction ratio and the second reduction ratio is less than 1.

The wind speed of the air flowing through the second contracting rectifying passage 2683 is faster than the wind speed of the air flowing through the first contracting rectifying passage 2681. Therefore, the rectification performance of the air flowing through the second contracting rectifying passage 2683 can be further improved by making the second reduction ratio smaller than the first reduction ratio, compared with a case where the second reduction ratio is the same as the first reduction ratio.

The present embodiment can achieve the effects and advantages, which are obtained from the structure common to the first embodiment.

### Other Embodiments

(1) In the rectifying mechanism 26 of the fourth embodiment, the cross section of the rectifying plates 261a and 261b, corresponding to the line III-III in FIG. 3, has a bent shape. Alternatively, for example, the rectifying plates 261a and 261b may have a curved shape in the cross section.

(2) In each of the embodiments, the rectifying plates 261 to 262 are arranged between the first tubular portion 263a to the third tubular portion 263c arranged concentrically. The rectifying plate may be arranged between two concentrically arranged tubular portions, or may be arranged between four or more concentrically arranged tubular portions.

The present disclosure is not limited to the above-described embodiments, and can be appropriately modified. Individual elements or features of a particular embodiment are generally not limited to that particular embodiment, but, where applicable, are interchangeable and can be used in a selected embodiment, even if not specifically shown or described. Further, in each of the above-mentioned embodiments, it goes without saying that components of the embodiment are not necessarily essential except for a case in which the components are particularly clearly specified as essential components, a case in which the components are clearly considered in principle as essential components, and the like. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Further, in each of the embodiments described above, when materials, shapes, positional relationships, and the like, of the components and the like, are mentioned, they are not limited to these materials, shapes, positional relationships, and the like, unless otherwise specified and unless limited to specific materials, shapes, positional relationships, and the like.

### (Overview)

According to the first aspect shown in a part or all of the embodiments, the air-conditioning unit of the present embodiment has the air-conditioning case in which the in-case passage is formed for air blown into the cabin. Further, the air-conditioning unit has a blower configured to blow out air sucked from one side in the axial direction by the rotation of the blower fan rotating around the fan axis in the in-case passage. The air-conditioning unit is equipped with a rectifying mechanism that is arranged downstream of the blower fan in the air flow inside the in-case passage. The rectifying mechanism has a rectifying passage that rectifies the swirling flow generated by the rotation of the blower fan after the air is blown out from the blower fan.

The rectifying mechanism has a contracting rectifying passage in which the flow path area of the outlet where the rectified air flows out is smaller than the flow path area of the inlet where the swirling flow flows in.

According to the second aspect, the rectifying mechanism has plural rectifying plates that partition the rectifying passage. The thickness of the rectifying plate in the thickness direction is longer on the outlet side where the rectified air flows out than on the inlet side where the swirling flow flows in, so that the contracting rectifying passage is formed.

Thus, the length of the rectifying plate in the thickness direction is longer on the outlet side where the rectified air flows out than on the inlet side where the swirling flow flows in. The contracting rectifying passage can be formed by arranging the rectifying plates.

According to the third aspect, the rectifying mechanism has the rectifying plates that partition the rectifying passage. The rectifying plates are arranged side by side so as to extend from the inlet where the swirling flow flows in to the outlet where the rectified air flows out. The distance between the rectifying plates is shorter on the outlet side where the rectified air flows out than on the inlet side where the swirling flow flows in, so that the contracting rectifying passage is formed.

The contracting rectifying passage can be formed by arranging the rectifying plates so that the distance between the rectifying plates is shorter on the outlet side where the rectified air flows out than on the inlet side where the swirling flow flows in.

According to the fourth aspect, the rectifying mechanism has the rectifying plates that partition the rectifying passage. Further, the length of the rectifying plate in the thickness direction is longer on the outlet side where the rectified air flows out than on the inlet side where the swirling flow flows in, so that the contracting rectifying passage is formed. The end portion of the rectifying plate adjacent to the inlet, into which the swirling flow flows, is curved along the flow direction of the swirling flow flowing into the inlet.

In this way, since the end portion of the rectifying plate adjacent to the inlet of the contracting rectifying passage is curved along the flow direction of the swirling flow flowing into the inlet, the swirling flow generated by the rotation of the blower fan can be efficiently introduced into the contracting rectifying passage.

Further, since the rectifying mechanism 26 does not have an enlarging rectifying passage, the swirling flow generated by the rotation of the blower fan can be rectified extremely efficiently.

According to the fifth aspect, the contracting rectifying passage has a first contracting rectifying passage and a second contracting rectifying passage. The rectifying mechanism includes a first tubular portion, a second tubular portion arranged radially outside the first tubular portion so as to surround the first tubular portion, and a third tubular portion arranged on the radially outside of the second tubular portion so as to surround the second tubular portion.

The first rectifying plates are arranged between the first tubular portion and the second tubular portion to form the first contracting rectifying passage between the first tubular portion and the second tubular portion. The second rectifying plates are arranged between the second tubular portion and the third tubular portion to form the second contracting rectifying passage between the second tubular portion and the third tubular portion.

The ratio of the flow path area of the outlet where the rectified air flows out from the first contracting rectifying passage to the flow path area of the inlet where the swirling flow flows in the first contracting rectifying passage is defined as the first reduction ratio. Further, the ratio of the flow path area of the outlet where the rectified air flows out from the second contracting rectifying passage to the flow path area of the inlet where the swirling flow flows in the second contracting rectifying passage is defined as the second reduction ratio. In this case, the second reduction ratio is smaller than the first reduction ratio.

The wind speed of the air flowing through the second contracting rectifying passage is faster than the wind speed of the air flowing through the first contracting rectifying passage. Therefore, the rectification performance of the air flowing through the second contracting rectifying passage can be further improved by making the second reduction ratio smaller than the first reduction ratio, as compared with a case where the second reduction ratio is the same as the first reduction ratio.

What is claimed is:

1. An air-conditioning unit for a vehicle, comprising:
an air-conditioning case in which an in-case passage is defined for air to be blown into a cabin;
a blower having a blower fan arranged in the in-case passage to rotate around a fan axis so as to blow out air sucked from one side in an axial direction of the fan axis; and
a rectifying mechanism arranged downstream of the blower fan in a flow of air in the in-case passage, a rectifying passage being defined in the rectifying mechanism to rectify a swirling flow generated by rotation of the blower fan relative to the air blown from the blower fan, wherein
the rectifying mechanism includes a contracting rectifying passage having an inlet into which the swirling flow flows and an outlet through which the rectified air flows out, and
a flow path area of the outlet is smaller than a flow path area of the inlet.

2. The air-conditioning unit claimed in claim 1, wherein
the rectifying mechanism has a plurality of rectifying plates to partition the rectifying passage, and
a dimension of the rectifying plate in a thickness direction is longer at the outlet than at the inlet so as to form the contracting rectifying passage.

3. The air-conditioning unit according to claim 1, wherein
the rectifying mechanism has a pair of rectifying plates to partition the rectifying passage,
the pair of rectifying plates are arranged to extend from the inlet to the outlet, and
an interval between the pair of rectifying plates is smaller at the outlet than at the inlet so as to form the contracting rectifying passage.

4. The air-conditioning unit according to claim 1, wherein
the rectifying mechanism has a plurality of rectifying plates to partition the rectifying passage,
a dimension of the rectifying plate in a thickness direction is longer at the outlet than at the inlet so as to form the contracting rectifying passage, and
an end portion of the rectifying plate adjacent to the inlet into which the swirling flow flows is curved along a flow direction of the swirling flow flowing into the inlet.

5. The air-conditioning unit according to claim 1, wherein
the contracting rectifying passage has a first contracting rectifying passage and a second contracting rectifying passage,
the rectifying mechanism includes
a first tubular portion,
a second tubular portion arranged radially outside the first tubular portion so as to surround the first tubular portion,
a third tubular portion arranged radially outside the second tubular portion so as to surround the second tubular portion,
a plurality of first rectifying plates arranged between the first tubular portion and the second tubular portion to form the first contracting rectifying passage between the first tubular portion and the second tubular portion, and
a plurality of second rectifying plates arranged between the second tubular portion and the third tubular portion to form the second contracting rectifying passage between the second tubular portion and the third tubular portion,
a first reduction ratio is a ratio of a flow path area of an outlet of the first contracting rectifying passage with respect to a flow path area of an inlet into which the swirling flow flows in the first contracting rectifying passage,
a second reduction ratio is a ratio of a flow path area of an outlet of the second contracting rectifying passage with respect to a flow path area of an inlet into which the swirling flow flows in the second contracting rectifying passage, and
the second reduction ratio is smaller than the first reduction ratio.
